(19) United States
(12) Patent Application Publication
(10) Pub. No.: US 2018/0062673 A1
(43) Pub. Date: Mar. 1, 2018

(54) METHOD AND DEVICE FOR FORMING A WIRELESS SIGNAL

(71) Applicant: TELEFONAKTIEBOLAGET LM ERICSSON (PUBL), Stockholm (SE)

(72) Inventors: Martin Sjödin, Göteborg (SE); Björn Gävert, Göteborg (SE)

(21) Appl. No.: 14/912,320

(22) PCT Filed: Feb. 9, 2016
(86) PCT No.: PCT/EP2016/052656

§ 371 Date: Feb. 16, 2016

(51) Int. Cl. H04B 1/04; H04B 1/10

(52) U.S. Cl. CPC H04B 1/0475; H04B 1/1027; H04L 1/0035; H04B 2001/1054; H04B 2001/0416

(57) ABSTRACT

A receiver for signals, comprising an amplifier arranged to receive and amplify the signals received by the receiver. The receiver also comprises a linearizer arranged to linearize the amplitude value of the output signals from the amplifier. In the receiver, the linearizer is arranged to perform said linearizing by means of determining actual and desired values of a statistical function for the amplitude values of the output signals from the amplifier and to replace the amplitude values of the output signals from the amplifier with amplitude values which have the same desired values of the statistical function. In embodiments of the receiver, the statistical function is the cumulative distribution function.

### TECHNICAL FIELD

The present disclosure relates to a method, a device, a computer program and a computer program product for forming a wireless signal in a transmission device for wireless communication.

### BACKGROUND

Wireless communication comprises transmission of information via a wireless signal from one or more transmitters to one or more receivers. In order for a receiver to be able to recover the transmitted information, the received signal cannot be overly distorted, i.e., too different from the transmitted signal.

Distortion of the received signal may result from addition of, e.g., thermal noise in the receiver and interference from other wireless transmissions. The effects of such additive distortion may often be alleviated by increasing transmitted power. This is because the relative power of the received wireless signal then increases in relation to the added distortion, improving signal to noise and interference ratio (SINR).

However, distortion also arises in the transmitter. For instance, all power amplifiers (PA) are limiting in the sense that they can only output signals in a given range of amplitude values. PAs will therefore limit or clip a transmitted signal with too high amplitude peaks, which effect becomes more pronounced the higher the output power is in relation to the capabilities of the PA. Such clipping will show up in frequency domain as spectral growth, where the spectral content of the transmitted signal outside of the intended transmission band increases in power. This is a problem since a transmitted signal is often required by regulation to be within a spectral transmission mask. If one increases output power too much, too extensive clipping of the signal will result, which may cause a breach of the mask due to said spectral growth.

Consequently, a trade-off needs to be made between maximizing output power on one hand, in order to overcome the additive type of distortion discussed above, and keeping distortion from clipping at an acceptable level on the other hand. Such trade-off is commonly referred to as a back-off level, where the output power is reduced, or backed off, from a maximum output power, in order to limit distortion due to clipping and keep spectral growth at an acceptable level.

It is desirable to maintain as low back-off level as possible, since the back-off level directly influences output power, and therefore also the relative power of additive distortion experienced by a receiver. Thus, there is need for improved ways of forming a wireless signal transmitted from a wireless device which allows for reduced back-off levels while still meeting requirements on the wireless system.

### SUMMARY

In view of above-mentioned and other drawbacks of the prior art, it is an object of the present invention to provide an improved method, device and system for transmitting a wireless signal.

According to a first aspect, it is provided a method for forming a wireless signal transmitted from a wireless device. The method comprises obtaining a symbol rate of the transmitted signal, and if the obtained symbol rate is below a corresponding reference symbol rate, limiting a peak amplitude of the wireless signal based on the obtained symbol rate.

Hereby, the dynamic range of the transmitted signal is reduced, which allows for an increase in transmitted power. Consequently, the system becomes less sensitive to the type of additive distortion discussed above.

Also, the negative effect of the distortion introduced by the limiting of peak amplitude is often small in comparison to the benefits in terms of SINR due to the increase in transmitted power, which implies an increase in overall system gain of the wireless communication system.

According to some aspects, limiting a peak amplitude comprises reducing a peak amplitude of the wireless signal below a peak amplitude reference level.

Hereby, the output power can be increased compared to in a system allowing peak amplitudes up to a reference level.

According to some aspects the method comprises controlling a transmission power of the wireless signal such that a transmission power is above a reference transmission power level, if the obtained symbol rate is below a corresponding reference symbol rate.

Hereby, the sensitivity to noise in a receiver is reduced.

According to some aspects, controlling a transmission power of the wireless signal comprises increasing a transmission power such that a power spectral density of the signal is within, i.e., complies with, a predetermined transmission mask.

Hereby, a signal transmitted with an increased transmission power complies with the transmission mask.

According to some aspects, limiting the peak amplitude of the wireless signal comprises reducing a crest factor of the wireless signal. By reducing the dynamic range of the signal using CFR, based on a symbol rate below a reference symbol rate, the margins to a spectral mask are utilized to enable a higher output power.

According to some aspects, limiting the peak amplitude of the wireless signal comprises reducing a back-off compared to an output power. Hereby, an increased output power is allowed.

According to some aspects, the method further comprises receiving, in the wireless device, information from a receiving device indicative of a power of a received signal; and if the received power is below a predetermined reference value, reducing the symbol rate, limiting a peak amplitude of the wireless signal and increasing an output power of the wireless device.

Hereby, an increase in transmitted power is made possible when needed due to low received power at the receiving device. Consequently, the system becomes less sensitive to the type of additive distortion discussed above and a functioning communication link can be maintained even in adverse communication conditions such as during rain-fading.

The object stated above is further obtained by a wireless transmitter configured to form a wireless signal to be transmitted, the transmitter comprising a control unit configured to obtain a symbol rate of a transmitted signal. If the obtained symbol rate is below a corresponding reference symbol rate, the control unit is configured to form the wireless signal by limiting a peak amplitude of the wireless signal based on the obtained symbol rate.

Hereby, as discussed above in connection to the method for forming a wireless signal, limiting a peak amplitude of the signal based on the obtained symbol rate of the signal allows for an increased overall output power from the wireless transmitter.

Moreover, according to some aspects, the output power of the transmitter is maximized while the power spectral density of the signal is within a predetermined transmission mask. Thereby, a signal can be formed which has the maximum power, or at least an increased power, for a given modulation format and symbol rate, compared to existing systems.

Further aspects discussed above in relation to the method for forming a wireless signal are equally applicable for the wireless transmitter. In particular, the above described method can be implemented in and performed by the wireless transmitter.

The object stated above is further obtained by a wireless communication system comprising a transmitter as described above and a receiver arranged to receive the transmitted signal, wherein the receiver is configured to provide information indicative of a power of a received signal to the transmitter, if the received power is below a predetermined threshold value. The control unit of the transmitter is configured to reduce the symbol rate, limit a peak amplitude of the wireless signal and increase an output power of the wireless device.

Hereby, the output power of the transmitter is increased such that the power of the received signal in the receiver is above a reference power level.

According to some aspects, the transmitter of the wireless communication system is configured to increase an output power to increase an availability of a wireless link.

According to some aspects, the transmitter of the wireless communication system is configured to increase an output power to increase a hop distance of a wireless link.

According to some aspects, the transmitter of the wireless communication system is configured to increase an output power to increase a reliability of transmitted data of a wireless link.

The object stated above is further obtained by a wireless transmitter configured to form a wireless signal to be transmitted. The transmitter comprises means for obtaining a symbol rate of a transmitted signal, and means for forming the wireless signal by limiting a peak amplitude of the wireless signal based on the obtained symbol rate if the obtained symbol rate is below a corresponding reference symbol rate.

The wireless transmitters and communication systems disclosed herein all display advantages corresponding to the advantages already mentioned in relation to the methods described above.

There is also provided a computer program comprising computer program code which, when executed in a node of a communication system, causes the wireless transmitter to execute any of the above described methods.

There is also provided a computer program product comprising a computer program as described above and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The invention is now described, by way of example, with reference to the accompanying drawings, in which:

FIGS. 1A-F are flow charts outlining general features of methods according to embodiments of the present technique;

FIG. 2 is a flow-chart outlining the general features of a method according to embodiments of the present technique;

FIG. 3 is a schematic illustration of a transmitter according to embodiments of the present technique;

FIG. 4 is a schematic illustration of a transmitter according to embodiments of the present technique;

FIG. 5 is a schematic illustration of a wireless communication system according to embodiments of the present technique; and

FIGS. 6A-D are graphs illustrating the power spectral density of signals formed according to embodiments of the present technique.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

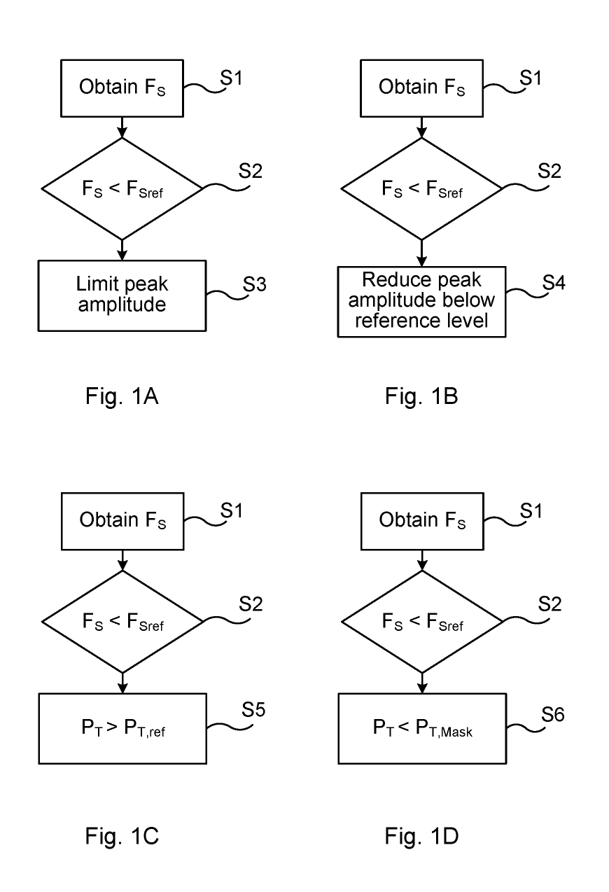

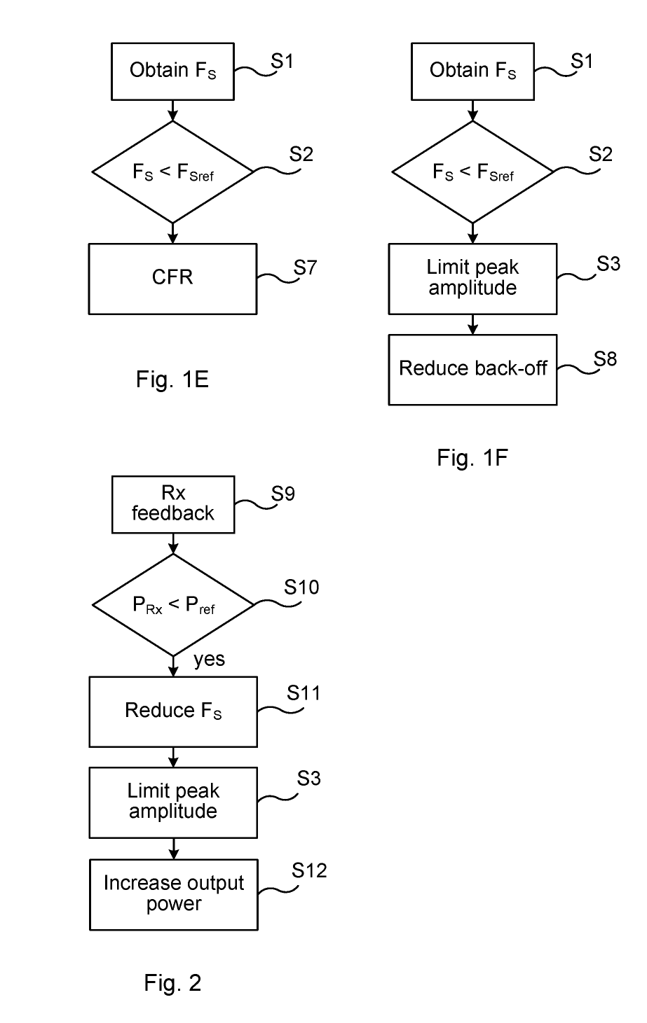

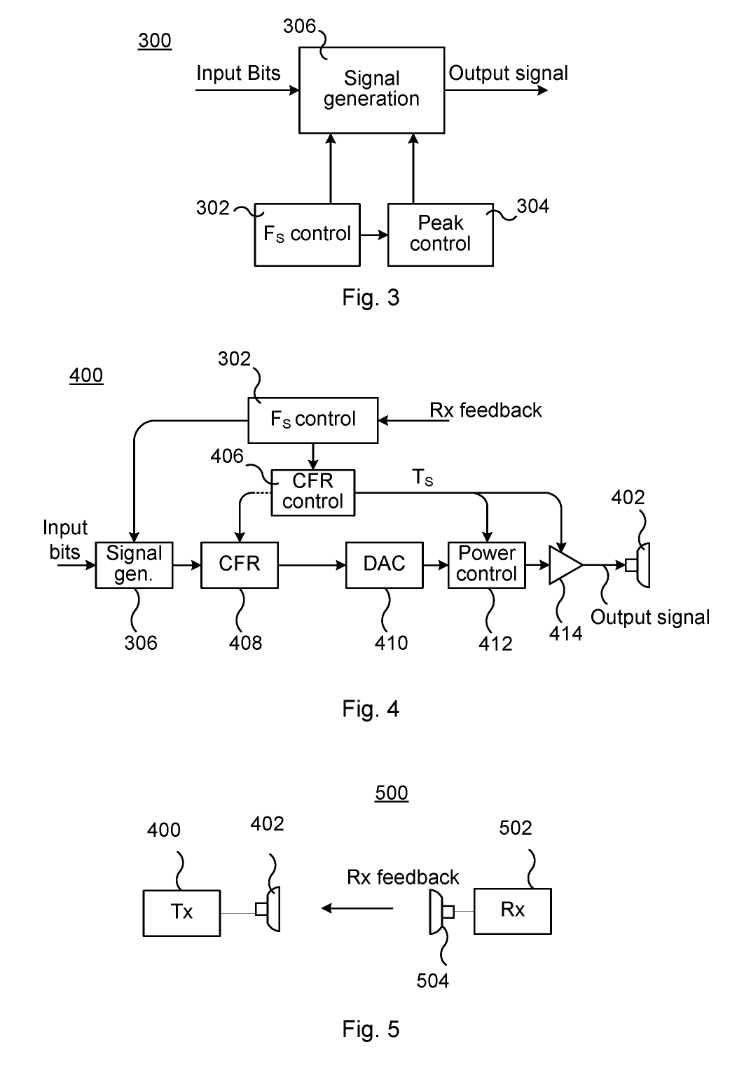

In the following detailed description, various aspects of the method and transmitter for forming a wireless signal according to the present technique are mainly described with reference to a transmitter for use in a communications system. The methods outlined by the flow charts of FIGS. 1A-E will be discussed with reference to the schematic illustration of a transmitter 300 illustrated in FIG. 3

FIG. 1A is a flow chart illustrating a method for forming a wireless signal transmitted from a wireless device, the method comprising; obtaining, S1, a symbol rate of the transmitted signal, and if, S2, the obtained symbol rate is below a corresponding reference symbol rate, limiting, S3, a peak amplitude of the wireless signal based on the obtained symbol rate.

The symbol rate F_{S} is defined as the inverse of the symbol time T_{S}, i.e. F_{S}=1/T_{S}. The obtained symbol rate is the symbol rate currently used by the transmitter for transmitting a signal, which can be obtained from symbol rate control circuitry 302 of the transmitter 300 or from memory or from a register configured to store such configuration data. Next, the obtained symbol rate is compared to a reference symbol rate F_{Sref} and if F_{S}<F_{Sref}, the peak amplitude of the wireless signal is reduced based on the obtained symbol rate F_{S}. The peak amplitude can for example be reduced using crest factor reduction (CFR), as will be discussed in further detail below. The peak amplitude is determined by peak control circuitry 304. The reference symbol rate F_{SRef} can for example be predetermined by an operator for a given modulation method, or it can be otherwise provided to the symbol rate control circuitry 302. According to some aspects, the reference symbol rate is the maximum allowable symbol rate for a particular transmission channel.

According to some aspects, a proper peak amplitude for a reference symbol rate is typically known. Thus according to some aspects, proper peak amplitude levels related to different conditions, like a reference symbol rate, can be obtained from the peak control circuitry 304 or from memory or from a register configured to such configuration data.

By means of the method outlined in FIG. 1A, if the symbol rate of a transmitted signal, for a given modulation format (the mapping between information bits and analog waveforms), is below a reference symbol rate, limiting a peak amplitude of the signal allows for an increased overall output power of the signal with a power spectral density (PSD) of the signal still being within a required spectral transmission mask.

Herein, the output power is the output power from a power amplifier in the transmitter, the output power can be seen as equivalent to the transmission power which is the power used for signal transmission. The amplifier output power is typically limited by the saturation of the power amplifier. Moreover, increasing the output power such that the amplifier operates closer to the saturation, i.e. reducing back-off, leads to increased clipping of the signal which in turn leads to spectral growth. Accordingly, the output power, and thereby the transmission power, may in practice be limited by a transmission mask defining the allowable power spectrum of a signal.

Reducing the dynamic range of the transmitted signal allows for increasing the output power, which hence allows improving the wireless communication system gain. Also, the negative effect of the distortion introduced by limiting the peak amplitude is often small in comparison to the benefits in terms of SINR due to the increase in transmitted power, which implies an increase in overall system gain of the wireless communication system.

Forming a wireless signal herein means that a pre-existing signal, i.e., a modulated communications signal such as a quadrature amplitude modulated (QAM) signal, is modified, or shaped, according to the described methods, prior to being transmitted by the transmitter. Forming in the present context is according to some aspects interpreted to mean creating, i.e. generating a signal to be wirelessly transmitted by a transmitter. Accordingly, forming the signal relates to determining the properties of the signal, which signal is subsequently transmitted.

Both the F_{S} control circuitry 302 and the peak control circuitry 304 provide input control signals to a signal generating unit 306 as illustrated in FIG. 3. The F_{S} control circuitry 302 also provides symbol rate information to the peak control circuitry, such that peak amplitude is determined based on the symbol rate. The signal generating unit 306 receives input bits to be communicated and provides an output in the form of an output signal to be transmitted.

By forming a signal at a symbol rate lower than a reference symbol rate, i.e. at a reduced symbol rate, additional system gain in a communications link is achieved. In particular, the increased margins to a transmission mask resulting from a reduction in symbol rate are utilized, as will be illustrated in further detail in the following. Furthermore, it is possible to operate at a higher order modulation for a longer time before there is a need to change to a lower order modulation when the transmitted signal is being degraded by e.g. fading events.

Note that transmitted number of bits/sec (bps) is a function of modulation order and symbol rate. A reduced symbol rate usually results in a reduction in transmitted bps.

However, by the present technique, a reduced symbol rate may in fact have a positive effect on transmitted bps. This is because a reduced symbol rate here allows for an increase in transmitted power, which in turn may permit use of a higher order modulation compared to a system which uses a lower transmitted power.

To give an example, suppose system A and system B both are transmitting data at 10 symbols/sec using 16-QAM (4 bits/symbol), i.e., at 40 bps. Suppose then rain-fading occurs, which forces system A to step down the modulation order to 4-QAM (2 bits/symbol). System B on the other hand reduces the symbol rate down to 8 symbol/sec which allows for an increase in transmitted power which is sufficient to maintain transmission at 16-QAM. System A then transmits at 20 bps, while system B transmits at 32 bps.

As illustrated in FIG. 1B, limiting the peak amplitude comprises reducing, S4, a peak amplitude of the signal below a reference peak amplitude level. The peak amplitude reference level relates to the maximum instantaneous power allowed by the transmitter. Herein, maximum instantaneous power might be the saturated (output) power of a power amplifier. According to some aspects, the peak amplitude reference level is the peak amplitude used for a reference symbol rate being higher than the obtained symbol rate. According to some aspects, a peak amplitude reference level is the corresponding maximum peak amplitude related to a certain reference symbol rate. Thus according to some aspects, a reference symbol rate and corresponding reference peak amplitude level together fulfills requirements like spectrum mask, BER and SNR. A reference peak level can also be based on a selected quota between a peak amplitude and an average (RMS) amplitude power of the signal, which is also referred to as the crest factor of the signal.

FIG. 1C is a flow chart illustrating a method where, if the obtained symbol rate is below a corresponding reference symbol rate, a transmission power of the wireless signal is controlled, S5, such that a transmission power is above a reference transmission power level. A reference symbol rate is a symbol rate which combined with a reference transmission power level fulfils necessary system requirements including a spectrum mask. According to some aspects, a reference power level is configurable by an operator in an interval limited by the used hardware and communication regulations defining for example a transmission mask. A hardware limited reference power level is limited by the maximum output power of the non-linear component used, such as the saturated power for a power amplifier. The reference transmission power level can for example be the transmission power level used for a reference symbol rate being higher than the obtained symbol rate.

FIG. 1D is a flow chart illustrating a method where controlling the transmission power of the transmitter comprises increasing, S6, a transmission power such that a power spectral density of the signal is within a predetermined transmission mask. If the symbol rate is reduced, the margin to a transmission mask is increased. Reducing the peak amplitude of the signal will reduce the dynamic range of the signal. The reduction of the peak amplitude might utilize the margin to the transmission mask. Accordingly, the output power is increased to increase the system gain while maintaining the power spectral density of the signal within a transmission mask to fulfill system requirements.

According to another aspect, the method comprises maximizing an output power of the wireless device. Thereby, the wireless device is fully utilized in order to achieve the highest possible system gain for a given modulation format and symbol rate.

FIG. 1E is a flow chart illustrating a method where limiting a peak amplitude of the wireless signal comprises reducing, S7, a crest factor of the wireless signal. The crest factor is determined as the ratio between the peak amplitude and the root-mean-square (RMS) value of the signal, and crest factor reduction can be used to reduce the dynamic range of the transmitted signal. In practice, limiting a peak amplitude often means that also the crest factor is reduced. CFR reduces the dynamic range of a signal, for example by hard clipping of the peaks of the signal at a predetermined power level. CFR can also be performed using CFR algorithms known to a person skilled in the art, such as, clipping/windowing, etc. as exemplified in Fehri et al, Crest Factor Reduction of Inter-Band Multi-Standard Carrier Aggregated Signals, IEEE TRANSACTIONS ON MICROWAVE THEORY AND TECHNIQUES, VOL. 62, NO. 12, DECEMBER 2014.

Accordingly, in a method utilizing CFR, the following sequence of events is performed: a reduced symbol rate is identified, which in turn leads to increased margins to a transmission mask. As a result of the increased margins the crest factor of the signal can be reduced, with the constraint that the signal should be kept within the transmission mask, and the reduced crest factor in turn leads to that the output power can be increased.

In the flow chart of FIG. 1F, a method is illustrated where forming the wireless signal further comprises reducing, S8, a back-off compared to a reference output power. By limiting the peak amplitude of the signal, an amplifier providing the output signal can operate closer to its maximum output power, i.e. with a reduced back-off, without excessive clipping of the signal. Accordingly, limiting the peak amplitude of the signal leads to reduced distortion from clipping in the amplifier since a signal having a lower peak amplitude will experience less clipping, which in turn allows an increased output power. Moreover, it can be seen that a reduction in peak amplitude in the form of a crest factor reduction allows a reduced back-off.

FIG. 2 is a flow chart illustrating a method comprising receiving, S9, in the wireless device, information from a receiving device indicative of a power of a received signal; and if, S10, the power of the received signal is below a predetermined reference value, reducing, S11, the symbol rate and limiting, S3, a peak amplitude of the wireless signal and increasing an output power of the wireless device

When the method outlined by FIG. 2 is employed in a communication system comprising a transmitter and a receiver, information indicative of the power of received signal can be used to determine if the output power of the transmitter is sufficient for transmitting a signal fulfilling the system requirements relating e.g. to bit error rate (BER) and signal-to-noise ratio (SNR). Accordingly, if the power of the received signal is below a predetermined reference power value, the output power of the transmitter can be increased by reducing the symbol rate and limiting the peak amplitude of the signal. For example, the symbol rate may be reduced by a predetermined factor, after which the crest factor is reduced and the output power is increased. Thereby, the need to change to a lower order modulation format can be avoided, or at least delayed depending on if the signal transmission is further degraded.

Instead of, or in addition to, information indicative of the power of the received signal, other performance measures of the received signal can be used, such as log-likelihood ratio (LLR), mean square error (MSE), bit error rate (BER), received signal strength (RSS) etc. However, it should be noted that such performance measures are often in themselves indicative of the power of the received signal, in the sense that for many performance measures, the performance measure of the received signal is proportional to the power of the received signal.

FIG. 3 is a schematic illustration of a wireless transmitter 300 configured to form a wireless signal to be transmitted, the transmitter comprising: a control unit 302 configured to obtain a symbol rate of a transmitted signal, and if the obtained symbol rate is below a corresponding reference symbol rate, to form the wireless signal by limiting a peak amplitude of the wireless signal based on the obtained symbol rate.

The transmitter 300 is configured to perform the above described methods such as wherein limiting a peak amplitude comprises reducing a peak amplitude of the wireless signal below a peak amplitude reference level.

According to some aspects, the control unit 302 unit is further configured to: if the obtained symbol rate is below a corresponding reference symbol rate, control a transmission power of the wireless signal such that a transmission power is above a reference transmission power level.

According to some aspects, the control unit 302 unit is further configured to control a transmission power of the wireless signal to increase a transmission power such that a power spectral density of the signal is within a predetermined transmission mask.

According to some aspects the control unit 302 is further configured to maximize an output power of the wireless device.

According to some aspects the control unit 302 is further configured to limit a peak amplitude of the wireless signal by reducing a crest factor of the wireless signal.

According to some aspects, the control unit 302 is further configured to limit a peak amplitude of the wireless signal by reducing a back-off compared to a reference output power.

The effects and advantages of the above described aspects of a transmitter are analogous to the effects and advantages described in relation to the various methods described above which can be performed by the transmitters.

FIG. 4 is schematically illustrating an example transmitter 400 in more detail, where CFR is utilized to limit the peak amplitude of the wireless signal based on feedback from a receiver, Rx feedback. The F_{S} control circuitry 302 determines if the symbol rate should be reduced based on the R_{X} feedback. The F_{S} control circuitry 302 further provides symbol rate information to the signal generation circuitry 306 and to a CFR control unit 406. In the illustrated example, the generated signal is provided to a CFR unit 408 where the crest factor is reduced, e.g. by reducing the peak amplitude of the signal, based on the control signals provided by the CFR control unit 406.

In the present example, CFR is performed for a digital signal. After CFR, the signal is DA-converted in a digital-to-analog converter (DAC) 410 and subsequently provided to a power control unit 412 where the power of the signal is controlled based on the symbol rate and the CFR. In particular, if the symbol rate has been reduced and CFR has been performed, the power can be increased. In principle, CFR can also be performed after DA-conversion of the signal, e.g. by clipping the signal. The power control unit 412 provides signal information to the power amplifier 414 which in turn provides the output signal to an antenna 402 for transmission.

In the transmitter of FIG. 4, the various features of the transmitter have been illustrated in the form of functional blocks. However, it is known to the skilled person that the described functions can be performed either by dedicated hardware circuitry for each function or by one or more multi-purpose control units, where several functions may be performed by one control unit. It is also known to a skilled person that the described functions can be implemented in either analogue or digital hardware, either as discrete components or as analogue integrated circuits and/or digital integrated circuits.

Accordingly, FIG. 4 illustrates a transmitter 400 having an adaptive symbol rate and adaptive CFR based on the symbol rate to improve a communications link under conditions where the quality of the transmitted signal is degraded.

It should be noted that the opposite scenario is also possible, where an R_{X} feedback signal indicates that the power of the received signal is higher than what is required. In that case, the symbol rate may be increased, the crest factor increased, and the output power may be reduced.

FIG. 5 schematically illustrates a wireless communication system 500 comprising a transmitter 400 according to any one of the aspects described above and a receiver 502 arranged to receive the transmitted signal, wherein the receiver is configured to provide information indicative of a power of a received signal to the transmitter, if the received power is below a predetermined threshold value; and wherein the control unit of the transmitter is configured to: reduce the symbol rate; limit a peak amplitude of the wireless signal; and increase an output power of the wireless device. The receiver comprises an antenna 504 for transmitting the feedback information, R_{X} feedback, to the transmitter 400.

According to some aspects, the transmitter is configured to increase an output power to increase an availability of a wireless link.

According to some aspects, the transmitter is configured to increase an output power to increase a hop distance of a wireless link.

According to some aspects, the transmitter is configured to increase an output power to increase a reliability of transmitted data of a wireless link.

The advantages related to the above communication system are analogous to those described in relation to the methods and transmitters above.

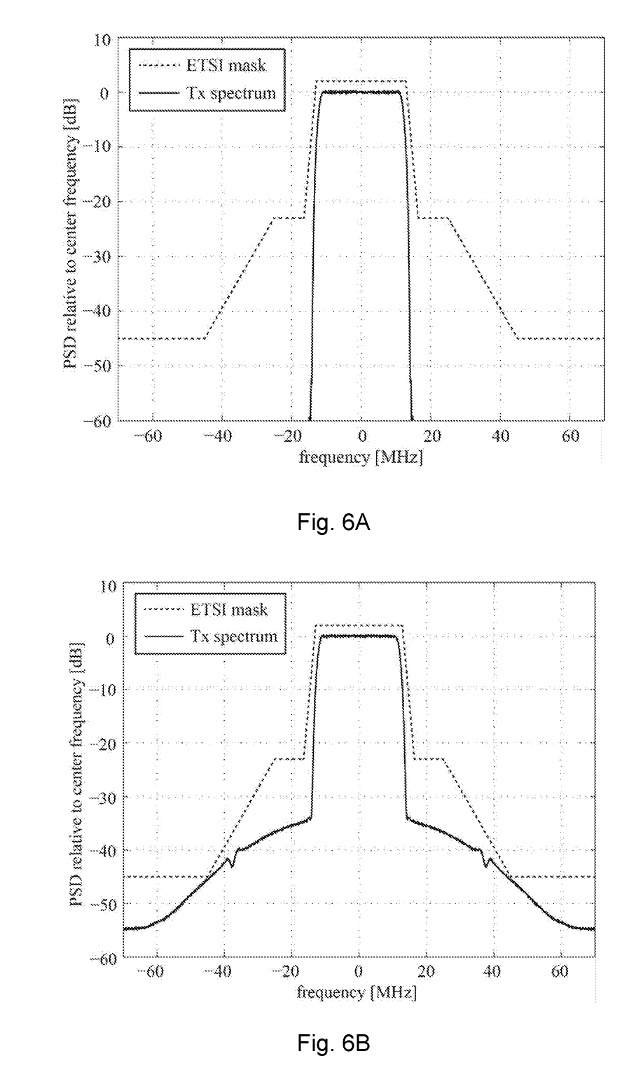

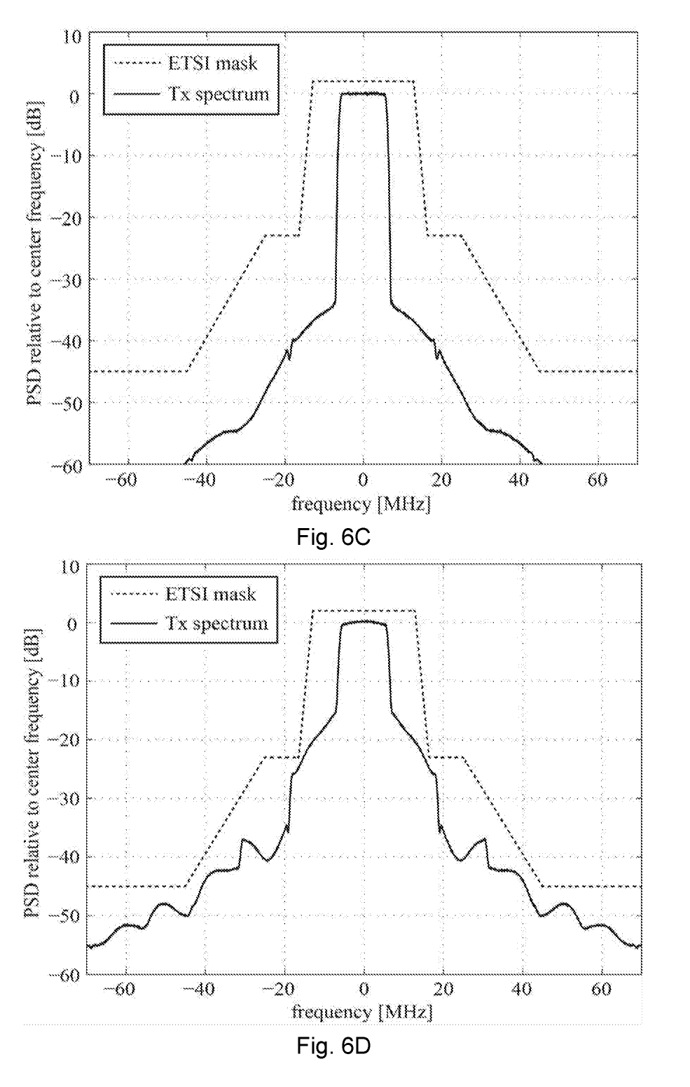

The graphs of FIG. 6A-D illustrate the above described methods and the functionality of a transmitter device performing the methods by illustrating the power spectral density relative to the center frequency of exemplary transmission signals.

The boundaries for a transmitted signal is according to some aspects set by a transmission mask defined by the European Telecommunications Standards Institute (ETSI), i.e. an ETSI mask defining an allowable channel, or frequency band, within which the power spectral density of the signal must be maintained. A purpose of the mask is to ensure channel separation by avoiding out of band emission for example by limiting the side lobes and by setting a ceiling for the maximum allowable signal power. An example ETSI-mask is illustrated by the dashed lines in FIGS. 6A-D. A transmission mask may also be defined according to the American National Standard for Telecommunications (ANSI).

FIG. 6A illustrates a transmitted signal spectrum, i.e. a Tx spectrum for a signal at a given modulation format and symbol rate. In the illustrated signal, no out of band distortion is visible, i.e. no distortion from for example a power amplifier or crest factor reduction is visible as out of band spectral growth.

FIG. 6B illustrates a signal spectrum of a signal having the same modulation format and symbol rate as the signal of FIG. 6A, but with a lower crest factor as a result of a limitation of a peak amplitude of the signal. In the present example, limiting a peak amplitude if the signal is performed using hard clipping to achieve crest factor reduction, allowing an improvement in system performance since the peak power is decreased.

FIG. 6C illustrates a spectrum for a signal where the symbol rate has been reduced compared to the signal illustrated in FIG. 6B. The symbol rate is reduced in a scenario when the Rx feedback indicates that the power of the received signal is too low.

In combination with the reduction of the symbol rate, the crest factor is reduced further and the output power is increased, yielding the signal illustrated in FIG. 6D where the margins to the transmission mask is once again reduced to better utilize the available spectrum. Accordingly, reducing the symbol rate allows the output power to be increased, since the crest factor is reduced, and the transmission of the signal is improved, albeit at a lower symbol rate.

The above described methods may be particularly useful for systems operating at high carrier frequencies (e.g., E-band D-band) where fading events due to rain are common requiring a temporarily increased output power.

It should be noted that the graphs of FIG. 6A-D are intended to illustrate the general concept of the above described methods, and that the methods may be utilized in a wide range of applications where it is advantageous to increase the output power from a transmitter and for transmission masks having different properties.

According to an aspect, there is further provided a wireless transmitter configured to form a wireless signal to be transmitted, the transmitter comprising: means 302 for obtaining a symbol rate of a transmitted signal, and means 408 for forming the wireless signal by limiting a peak amplitude of the wireless signal based on the obtained symbol rate if the obtained symbol rate is below a corresponding reference symbol rate.

According to an aspect, there is further provided a computer program comprising computer program code which, when executed in a node of a communication system, causes the wireless transmitter to execute a method according to any of the aspects described above.

According to an aspect, there is further provided computer program product comprising a computer program according to the above aspect and a computer readable means on which the computer program is stored.

Even though the invention has been described with reference to specific exemplifying embodiments thereof, many different alterations, modifications and the like will become apparent for those skilled in the art from a study of the drawings, the disclosure, and the appended claims. Also, it should be noted that parts of the method and transmitter may be omitted, interchanged or arranged in various ways, the method and transmitter yet being able to perform the functionality of the present invention. The mere fact that certain measures are recited in mutually different dependent claims does not indicate that a combination of these measured cannot be used to advantage. Additionally, variations to the disclosed embodiments can be understood and effected by the skilled person in practicing the claimed invention. In the claims, the word “comprising” does not exclude other elements or steps, and the indefinite article “a” or “an” does not exclude a plurality.

1. A method for forming a wireless signal transmitted from a wireless device, the method comprising;
obtaining a symbol rate of the transmitted signal, and
upon the obtained symbol rate being below a corresponding reference symbol rate, limiting a peak amplitude of the wireless signal based on the obtained symbol rate.

2. The method according to claim 1, wherein limiting a peak amplitude comprises reducing a peak amplitude of the wireless signal below a peak amplitude reference level.

3. The method according to claim 1, further comprising, upon the obtained symbol rate being below a corresponding reference symbol rate, controlling a transmission power of the wireless signal such that a transmission power is above a reference transmission power level.

4. The method according to claim 3, wherein controlling a transmission power of the wireless signal comprises increasing a transmission power such that a power spectral density of the signal is within a predetermined transmission mask.

5. The method according to claim 1, further comprising maximizing an output power of the wireless device.

6. The method according to claim 1, wherein limiting a peak amplitude of the wireless signal comprises reducing a crest factor of the wireless signal.

7. The method according to claim 1, wherein limiting a peak amplitude of the wireless signal comprises reducing a back-off level compared to a reference output power.

8. The method according to claim 1, further comprising:
receiving, in the wireless device, information from a receiving device indicative of a power of a received signal; and
if upon the power of the received signal being below a predetermined reference value, reducing the symbol rate and limiting a peak amplitude of the wireless signal and increasing an output power of the wireless device.

9. A wireless transmitter configured to form a wireless signal to be transmitted, the transmitter comprising:
a control unit a symbol rate of a transmitted signal, and
upon the obtained symbol rate being below a corresponding reference symbol rate, to form the wireless signal by limiting a peak amplitude of the wireless signal based on the obtained symbol rate.

10. The transmitter according to claim 9, wherein limiting a peak amplitude comprises reducing a peak amplitude of the wireless signal below a peak amplitude reference level.

11. The transmitter according to claim 9, wherein the control unit is further configured to, upon the obtained symbol rate being below a corresponding reference symbol rate, control a transmission power of the wireless signal such that a transmission power is above a reference transmission power level.

12. The transmitter according to claim 11, wherein the control unit is further configured to control a transmission power of the wireless signal to increase a transmission power such that a power spectral density of the signal is within a predetermined transmission mask.

13. The transmitter according to claim 9, wherein the control unit is further configured to maximize an output power of the wireless device.

14. The transmitter according to claim 9, wherein the control unit is further configured to limit a peak amplitude of the wireless signal by reducing a crest factor of the wireless signal.

15. The transmitter according to claim 9, wherein the control unit is further configured to limit a peak amplitude of the wireless signal by reducing a back-off level compared to a reference output power.

16. A wireless communication system comprising a transmitter and a receiver arranged to receive a transmitted signal, wherein the receiver is configured to provide information indicative of a power of a received signal to the transmitter, if the received power is below a predetermined threshold value; and wherein the control unit of the transmitter is configured to:
reduce the symbol rate;
limit a peak amplitude of the wireless signal; and
increase an output power of the wireless device.

17. The wireless communication system according to claim 16 wherein the transmitter is configured to increase an output power to increase an availability of a wireless link.

18. The wireless communication system according to claim 16 wherein the transmitter is configured to increase an output power to increase a hop distance of a wireless link.

19. The wireless communication system according to claim 16 wherein the transmitter is configured to increase an output power to increase a reliability of transmitted data of a wireless link.

20.-22. (canceled)
